(19) United States
(12) Patent Application Publication
(10) Pub. No.: US 2005/0160249 A1
(43) Pub. Date: Jul. 21, 2005

(54) Volume type determination for disk volumes managed by a LDM

(75) Inventor: Anand D. Sankruthi, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/760,348

(22) Filed: Jan. 21, 2004

(51) Int. Cl. G06F 12/00

(52) U.S. Cl. 711/170; 711/112; 711/114

(57) ABSTRACT

A method and apparatus is described which allows the determination of volume types of storage media residing in a computer system, where the volumes are managed using a Logical Disk Manager. This is achieved without analysing the LDM database which is conventionally stored in the last 1 Mb of each hard disk. The method according to the invention operates by inferring the volume type based on specific external and measurable characteristics of the volume and the disk on which it resides. Preferably, the characteristics used include the existence of an indicating string in the volume symbolic name and the way in which the volume occupies each LUN. That is, there are a specific number of volume types allowed, the disk extents of a simple volume can lie on only one disk and the sum of all disk extents of a mirrored/RAID volume exceeds the actual usable size of the volume. Thus the volume type can be determined indirectly and quickly. This information is used in volume creation/management.

### TECHNICAL FIELD

The present invention relates to storage media and storage devices. In particular, the invention relates to methods, apparatus and systems for the management of storage devices. In this sense, storage devices can be abstracted to the concept of Logical Units (LUNs) examples of which include individual Hard Disks (HDDs) and arrays of HDDS.

More particularly, although not exclusively, the invention relates to methods and apparatus for determining the volume type for volumes on computer LUNs where the computer is running the Windows operating system or a variant thereof.

### BACKGROUND ART

The most commonly used storage type found on computers running variants of the Windows operating system include storage devices in the form of basic disks and dynamic disks.

Basic disks contain what are known as basic volumes. In general, a volume refers to a fixed amount of storage residing on a computer-based storage device such as a disk or tape and may correspond to primary partitions and logical drives. The following discussion will focus on HD media. However, it is to be understood that the present invention may be applied equally to any volume-based storage media. The term volume is sometimes used as a synonym for the storage medium itself.

Basic disks, which are found in both x86-based and Itanium-based computers, represent the simplest type of storage solution that can accommodate variable storage requirements. Basic disks support clustered disks, IEEE 1394 disks, and USB removable drives.

Dynamic disks provide features that basic disks do not, such as the ability to create volumes that span multiple disks, i.e.; spanned and striped volumes, and the ability to create fault tolerant volumes such as mirrored and RAID volumes.

All volumes on dynamic disks are known as dynamic volumes. Dynamic disks are considered to provide generally greater flexibility for volume management because they use a database to track information about dynamic volumes on the disk as well as other dynamic disks in the computer.

To perform disk management tasks such as converting basic disks into dynamic disks, and creating fault-tolerant volumes the Logical Disk Manager (LDM) and Virtual Disk Service (VDS) are used.

The LDM is a default application provided under the Windows 2000 and onwards OS. It is accessed from the control panel. In the case of dynamic disks, the LDM is useful in creating volumes of various types and managing the size of the volumes.

The size and structure of these volumes can be determined via control functions (ioctls) provided in the Windows driver development kit (DDK). In addition, the symbolic names and the mount point of these volumes can also be obtained programmatically.

However, a problem arises where applications such as high level system management tools, for example the applicants OpenView Storage Area Manager (OVSAM), need to determine the specific type of the volume as there is no known api/ioctl which provides this information. The LDM provides for the creation and management of up to five different volume types: simple, spanned, stripe, mirrored and RAID.

It is theoretically possible to obtain the volume types from the LDM database that is stored in the last 1 Mb of space on the disk. However this method is laborious and difficult to implement due to the complexity of the LDM database. It is necessary to block read the whole 1 Mb database and attempt to parse the various fields in order to get the type of all the volume groups from the value of each byte in this block.

It would therefore be highly desirable if there existed a technique by which the volume types could be determined quickly and simply avoiding the procedures outlined above.

### DISCLOSURE OF THE INVENTION

In its broadest aspect, the invention provides for a method of determining volume types present on a storage device, the method including the steps of determining superficial specifying characteristics of an unknown volume on the storage device and correlating these against one or more previously determined volume characteristics thereby inferring the volume type.

The storage device may correspond to one or more data storage units such as disks, drives or similar.

The storage unit preferably corresponds to a disk or drive.

Therefore, the storage device preferably corresponds to a disk, array of disks or similar assembly of partitionable media.

The data storage units may be physical or logical.

Preferably, the specifying characteristics include identifying strings embedded in the symbolic names of each volume.

Preferably, the specifying characteristics further include characteristics related to how the volumes are physically arranged in the storage device.

The physical arrangement of the volumes on the storage device may include criteria such as the size of the storage unit extents of the volume in relation to the actual size of the volume.

RAID and striped volume types are preferably identified by corresponding strings present in the symbolic volume name.

If the volume is not previously identified as a RAID volume, the characteristic of the sum of the storage unit extents occupied by the volume being greater than the actual size of the volume preferably corresponds to a mirrored volume type.

The characteristic of the storage unit extents occupied by the volume being on the same storage unit preferably corresponds to a simple volume type.

If the volume is not previously identified as a RAID volume, the characteristic of neither the sum of the storage unit extents occupied by the volume being greater than the actual size of the volume nor the storage unit extents occupied by the volume being on the same storage device, preferably corresponds to a spanned volume type.

In a preferred aspect the invention provides for a method of determining the volume types present on a disk, the method including the steps of:
determining if the symbolic name of the volume contains information identifying the volume type as either “raid” or “striped” thereby indicating that the volume type is “raid” or “striped” respectively;
determining the size of all the storage unit extents occupied by the volume and the actual size of the volume;
determining if the sum of the storage unit extents is greater than the actual size of the volume thereby indicating that the volume type is “mirrored”;
determining if all storage unit extents lie on the same storage unit thereby indicating that the volume type is “simple”;
and, determining if the all storage unit extents do not lie on the same storage unit and that the sum of the storage unit extents is not greater than the actual size of the volume, thereby indicating that the volume type is “spanned”.

The invention also provides for a software tool adapted to operate in accordance with the methods as hereinbefore defined.

The invention further provides a system for managing volumes on storage devices including:
memory which stores specifying characteristics corresponding to one or more volume types;
a processor arranged to determine characteristics of volumes occupying storage devices which are present on the system and correlate the determined characteristics against the specified characteristics thereby inferring the volume type.

The inference step preferably includes extracting the symbolic name of the volume and if it includes the string RAID or striped, correlating that with the RAID and striped volume types respectively, and otherwise analysing the size of the storage unit extents occupied by the volume and if the sum of the storage unit extents is more than the actual size of the volume correlating that with a mirrored volume type, if the storage unit extents occupied by the volume all reside on the same storage unit, correlating that with a simple volume type and if none of the abovementioned criteria are met, correlating this with a spanned volume type.

The invention further provides for software for performing the method as hereinbefore defined.

The invention further provides for storage media carrying software adapted to perform the method as hereinbefore defined.

### BRIEF DESCRIPTION OF THE DRAWINGS

The present invention will now be described by way of example only and with reference to the drawings in which:

FIG. 1: a flowchart of the steps in one embodiment of the invention.

### BEST MODE FOR CARRYING OUT THE INVENTION

The present invention will be described in the context of a standard computer system running the Windows™ operating system or a variant thereof. Such systems generally incorporate storage devices in the form of a disk or disk drives which conform to the IDE or SCSI bus standard. For IDE drives, each unique disk drive is identified by its location on the primary or secondary IDE bus, with generally each IDE bus being capable of supporting up to two IDE devices. In the case of SCSI drives, each unique device on a SCSI bus is called a Logical Unit Number, or LUN. LUNs can also be used to describe discrete IDE disk units.

This is a unique identifier which allows devices sharing the same bus to be distinguished.

In this description, reference is made to storage devices comprising one or more data storage units. Here a data storage unit corresponds to a disk, drive or other separate unit of storage media on which a single volume defines a simple volume. To this end, the invention applies to partitionable storage devices examples of which include disks, disk arrays and uncorrelated disk assemblies. These devices can be collectively referred to as a ‘storage device’ in this description.

Data may be written onto disk storage media in a number of ways. Windows recognises five primary methods, RAID, striping, mirroring, simple and spanned.

RAID stands for Redundant Array of Independent/Inexpensive Disks. This is a technique which employs two or more drives in combination for fault tolerance and performance. RAID disk drives are used frequently on servers where high reliability/performance is required.

There are number of different RAID levels with the three most common being 0, 3, and 5. Level 0 provides data striping. That is, spreading out blocks of each file across multiple disks, but no inbuilt redundancy. This improves performance but does not provide fault tolerance. Level 1 provides disk mirroring. Level 3 is the same as Level 0, but also allocates a dedicated disk to error correction data. Level 3 provides good performance and a degree of fault tolerance. Level 5 provides data striping at the byte level and also error correction information. This results in generally relatively high performance and good fault tolerance.

Disk striping is a technique for spreading data over multiple disk drives. Disk striping can speed up operations that retrieve data from disk storage. According to this technique, the data is broken into portions which are then spread across the available disks in the computer system. Unlike disk mirroring, disk striping stores each data portion at only one location and does not offer protection from disk failure.

Disk mirroring corresponds to the situation where the contents of a discrete LUN or disk is replicated onto a physically separate unit of storage media. This provides for data redundancy should the primary disk integrity be compromised.

A simple disk volume is one where all of the data for a particular volume resides on a single physical disk or drive.

Finally, a spanned disk is where a volume extends across more than one LUN or physical disk with no duplication.

In each of these cases creating and managing the disk volumes requires knowledge of the volume types which are used on the system. As noted above, this is a difficult task given that there is no known ioctl/api which can provide this information.

The invention is predicated on a prior knowledge of the specific types of volumes that can exist and in particular the present embodiment relates to those on a Windows system hard disk or hard disks which are managed using the Windows LDM. The invention is further predicated on the characteristics of each individual volume type.

From this information the volume type is deduced indirectly thus obviating the need to access and interpret the LDM database.

It is noted that the technique according to the invention can be adapted to other Volume Managers assuming that there exists a sufficiently precise knowledge of the volume types which are managed under those regimes.

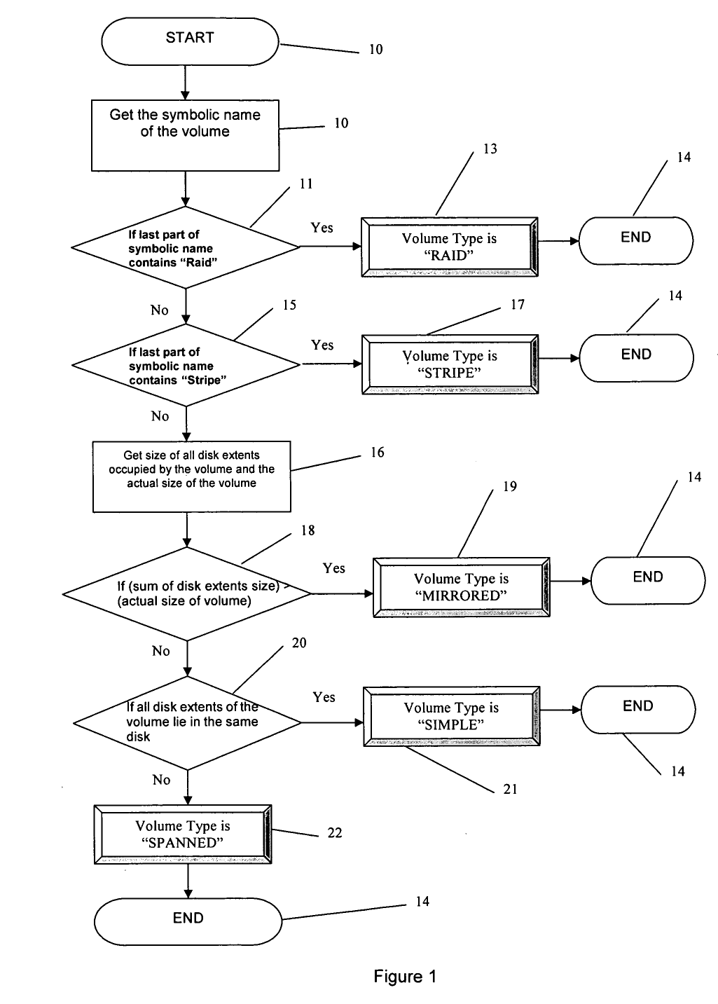

Referring to FIG. 1, one embodiment of the method of the present invention is illustrated. At a general level, the method operates by looking at each of the volumes and correlating certain of their characteristics with known characteristics of each of the different volume types.

Specifically, the certain characteristics which are used in the present embodiment of the invention are the existence of the strings “RAID” or “STRIPE” in the volume symbolic name as well as the storage unit extents, or parts of the physical disk(s) occupied, corresponding to each volume. For clarity, it will be assumed that the embodiment described herein includes disks as the data storage units.

The method is further based on the fact that there are a specific number of volume types allowed, that the disk extents of a simple volume can lie on only one disk and that the sum of all disk extents of a mirrored/RAID volume exceeds the actual usable size of the volume.

The first step in the embodiment of the method illustrated is to obtain (10) the symbolic name of the volume. This is parsed and if the last part of the symbolic name contains the string “RAID” (11) the volume type is identified (13) as a RAID volume. If the last part of the symbolic name contains (15) the string “STRIPE”, then the volume type is identified as striped (17). The symbolic names of a volume can be accessed via the ioctl “IOCTL_MOUNTMGR_QUERY_POINTS”, and for striped and RAID types, they will be:
“\Device\HarddiskDmVolumes\host1Dg0\Stripe#”and
“\Device\HarddiskDmVolumes\host1Dg0\RAI D#”
   respectively where “host1” is the hostname where the volumes are present and # is the stripe or RAID number.

Then the size of all disk extents occupied by the volume and the actual size of the volume is determined (16). If the sum of all the disk extents exceeds (18) the actual size of the volume, it is inferred that the volume type is mirrored (19). If all the disk extents of the volume lie in the same disk (20), then it is inferred (21) that the volume type is simple. If neither of the two criteria set out above are satisfied and no RAID or STRIPED strings are found in the volume name, it is inferred that the volume type is spanned (22).

It is noted that for RAID volume types, the sum of all the disk extents will also be greater than the actual volume size. However, the existence of a RAID volume will have been detected in the initial step of looking at the volume symbolic name strings. Thus detecting the disk extents will allow the accurate differentiation between mirrored, spanned and simple volume types.

Thus the volume types for each of the possible volumes in the system can be indirectly inferred from specific characteristics including the presence of identifying strings in their symbolic names and the way in which they occupy the disk extents. This inference process is performed without accessing the LDM database and can be executed quickly and effectively.

An application for implementing the invention has been written in C using the Windows Driver Development Kit. The application enumerates all of the known volume types present in a system by means of the inference technique outlined above. This has provided for a fast and effective way to implement volume management without a detailed analysis of the LDM database or otherwise by programmatic access.

Although the invention has been described by way of example and with reference to particular embodiments it is to be understood that modification and/or improvements may be made without departing from the scope of the appended claims.

Where in the foregoing description reference has been made to integers or elements having known equivalents, then such equivalents are herein incorporated as if individually set forth.

1. A method of determining volume types present on a storage device, the method including the steps of determining superficial specifying characteristics of an unknown volume on the storage device and correlating these against one or more previously determined volume characteristics thereby inferring the volume type.

2. A method as claimed in claim 1, wherein the storage device comprise one or more data storage units.

3. A method as claimed in claim 2, wherein the data storage unit corresponds to a disk or drive and/or is logical or physical.

4. A method as claimed in claim 3, wherein the storage device comprises a disk, array of disks or similar assembly of partitionable media.

5. A method as claimed in claim 1, wherein the specifying characteristics include identifying strings embedded in the symbolic names of each volume.

6. A method as claimed in claim 1, wherein the specifying characteristics further include characteristics related to how the volumes are physically arranged in the storage device.

7. A method as claimed in claim 6, wherein the physical arrangement of the volumes on the storage device include criteria corresponding to the size of the storage unit extents of the volume in relation to the actual size of the volume.

8. A method as claimed in claim 1, wherein RAID and striped volume types are identified by corresponding strings present in the symbolic volume name.

9. A method as claimed in claim 1 wherein, if the volume is not previously identified as a RAID volume, the characteristic of the sum of the storage unit extents occupied by the volume being greater than the actual size of the volume corresponds to a mirrored volume type.

10. A method as claimed in claim 1, wherein the characteristic of the storage unit extents occupied by the volume being on the same storage unit corresponds to a simple volume type.

11. A method as claimed in claim 1, wherein if the volume is not previously identified as a RAID volume, the characteristic of neither the sum of the storage unit extents occupied by the volume being greater than the actual size of the volume nor the storage unit extents occupied by the volume being on the same storage device, corresponds to a spanned volume type.

12. A method of determining the volume types present on a disk, the method including the steps of:
determining if the symbolic name of the volume contains information identifying the volume type as either “raid” or “striped” thereby indicating that the volume type is “raid” or “striped” respectively;
determining the size of all the storage unit extents occupied by the volume and the actual size of the volume;
determining if the sum of the storage unit extents is greater than the actual size of the volume thereby indicating that the volume type is “mirrored”;
determining if all storage unit extents lie on the same storage unit thereby indicating that the volume type is “simple”;
and, determining if the all storage unit extents do not lie on the same storage unit and that the sum of the storage unit extents is not greater than the actual size of the volume, thereby indicating that the volume type is “spanned”.

13. A system for managing volumes on storage devices including:
memory which stores specifying characteristics corresponding to one or more volume types;
a processor arranged to determine characteristics of volumes occupying storage devices which are present on the system and correlate the determined characteristics against the specified characteristics thereby inferring the volume type.

14. A system as claimed in claim 13, wherein the inference step includes extracting the symbolic name of the volume and if it includes the string RAID or striped, correlating that with the RAID and striped volume types respectively, and otherwise analysing the size of the storage unit extents occupied by the volume and if the sum of the storage unit extents is more than the actual size of the volume correlating that with a mirrored volume type, if the storage unit extents occupied by the volume all reside on the same storage unit, correlating that with a simple volume type and if none of the abovementioned criteria are met, correlating this with a spanned volume type.

15. A computer adapted to operate in accordance with claim 1.

16. A module adapted to function in accordance with claim 1.
